(19) United States
(12) Patent Application Publication
(10) Pub. No.: US 2018/0118154 A1
(43) Pub. Date: May 3, 2018

(54) GAS GENERATOR

(71) Applicant: DAICEL CORPORATION, Osaka-shi, Osaka (JP)

(72) Inventor: Shinichiro UKITA, Tatsuno-shi (JP)

(73) Assignee: DAICEL CORPORATION, Osaka-shi, Osaka (JP)

(21) Appl. No.: 15/568,047

(22) PCT Filed: Apr. 5, 2016
(86) PCT No.: PCT/JP2016/061118

§ 371 Date: Oct. 20, 2017

(30) Foreign Application Priority Data
May 29, 2015 (JP) 2015-110597

(51) Int. Cl. B60R 21/272; B01J 7/00

(52) U.S. Cl. CPC B60R 21/272; B60R 2021/26029; B01J 7/00

(57) ABSTRACT

The present invention provides a gas generator, including:

an ignition device disposed on the side of a first end portion of a cylindrical housing;

a diffuser portion provided with a gas discharge port, welded and fixed to the cylindrical housing on the side of a second end portion axially opposite to the first end portion;

a combustion chamber accommodating a gas generating agent and being arranged on the side of the first end portion;

a pressurized gas chamber being filled with a gas and arranged on the side of the second end portion;

a partition wall provided with a through hole in a thickness direction thereof and separating the combustion chamber from the pressurized gas chamber;

a rupturable plate closing between the pressurized gas chamber and the diffuser portion; and

a stopper means formed on an inner wall surface of the cylindrical housing, the stopper means stopping movement of the partition wall or reducing movement speed of the partition wall, before the partition wall collides with the diffuser portion, by coming into contact with the partition wall which moves in an axial direction upon receipt of a pressure of a combustion gas generated by combustion of the gas generating agent in the combustion chamber at the time of actuation.

### TECHNICAL FIELD

The present invention relates to a gas generator that is usable in an airbag apparatus to be installed on an automobile or the like.

### DESCRIPTION OF RELATED ART

Among gas generators that are used, there are hybrid type gas generators in which, as a gas generating source, a gas generating agent is used together with a pressurized gas, such as argon, helium or the like, filled under high pressure.

A known hybrid type gas generator is one in which an igniter is disposed on the side of a first end portion of a cylindrical housing, a diffuser is provided with a gas discharge port and disposed on the side of a second end portion which is on the axially opposite side, further, a gas generating agent-accommodating space in which a gas generating agent is accommodated is present on the side of the igniter, a pressurized gas-filled space which is filled with a pressurized gas is present on the side of the diffuser, the gas generating agent-accommodating space is separated from the pressurized gas-filled space by a partition wall, and a rupturable plate closes between the pressurized gas-filled space and the diffuser.

In U.S. Pat. No. 5,301,979, FIGS. 1 and 2 depict a hybrid type inflator having a space for accommodating a gas generating agent 24 on the side of an initiator 26 and a pressurized gas-filled space 14 on the side of a diffuser 36.

A piston 18 attached through a piston ring 19 separates the space for accommodating the gas generating agent 24 from the pressurized gas-filled space 14.

In U.S. Pat. No. 5,732,972, FIGS. 1 and 2 depict a hybrid type inflator having a space for accommodating a gas generating material 30 on the side of an initiator 32 and a pressurized gas-filled space 16 on the side of a diffuser 48.

A porous filter piston 24 separates a space for accommodating the gas generating material 30 from the pressurized gas-filled space 16.

A damper 44 is disposed through an end cap 46 to alleviate an impact on a welded portion 50 when the porous filter piston 24 moves in the axial direction and collides with the diffuser 48 at the time of actuation.

### SUMMARY OF INVENTION

The present invention provides a gas generator, including:

an ignition device disposed on the side of a first end portion of a cylindrical housing;

a diffuser portion provided with a gas discharge port, welded and fixed to the cylindrical housing on the side of a second end portion axially opposite to the first end portion;

a combustion chamber accommodating a gas generating agent and being arranged on the side of the first end portion;

a pressurized gas chamber being filled with a gas and arranged on the side of the second end portion;

a partition wall provided with a through hole in a thickness direction thereof and separating the combustion chamber from the pressurized gas chamber;

a rupturable plate closing between the pressurized gas chamber and the diffuser portion; and

a stopper means formed on an inner wall surface of the cylindrical housing, the stopper means stopping movement of the partition wall or reducing movement speed of the partition wall, before the partition wall collides with the diffuser portion, by coming into contact with the partition wall which moves in an axial direction upon receipt of a pressure of a combustion gas generated by combustion of the gas generating agent in the combustion chamber at the time of actuation.

### BRIEF DESCRIPTION OF DRAWINGS

The present invention will become more fully understood from the detailed description given hereinbelow and the accompanying drawings which are given by way of illustration only, and thus are no limitative of the present invention and wherein:

FIG. 1 shows a cross-sectional view in the long axial direction of a gas generator in which the present invention is used;

FIG. 2 shows a partial cross-sectional view depicting a state after actuation of the gas generator shown in FIG. 1 which additionally includes a stopper means for a partition wall, to illustrate an embodiment of the present invention;

FIG. 3 shows a partial cross-sectional view depicting a state after actuation of the gas generator shown in FIG. 1 which additionally includes another stopper means for a partition wall, to illustrate another embodiment of the present invention;

FIG. 4 shows a partial cross-sectional view depicting a state after actuation of the gas generator shown in FIG. 1 which additionally includes another stopper means for a partition wall, to illustrate yet another embodiment of the present invention;

FIG. 5 shows a partial cross-sectional view depicting a state after actuation of the gas generator shown in FIG. 1 which additionally includes another stopper means for a partition wall, to illustrate yet another embodiment of the present invention;

FIG. 6 shows a partial cross-sectional view depicting a state after actuation of the gas generator shown in FIG. 1 which additionally includes another stopper means for a partition wall, to illustrate yet another embodiment of the present invention; and

FIG. 7 shows a partial cross-sectional view depicting a state after actuation of the gas generator shown in FIG. 1 which additionally includes another stopper means for a partition wall, to illustrate yet another embodiment of the present invention.

### DETAILED DESCRIPTION OF INVENTION

In U.S. Pat. No. 5,301,979, at the time of actuation, the piston 18 moves in an axial direction and collides with the diffuser 36, and it is conceivable that the weld portion 38 might be broken by the impact at that time.

The inflator disclosed in U.S. Pat. No. 5,732,972 apparently is an invention to solve a problem of the inflator of U.S. Pat. No. 5,301,979, but requires two parts, namely, the end cap 46 and the damper 44, and a process of attaching them is also required.

The present invention is to provide a gas generator in which a gas generating agent and a pressurized gas are used together as a gas source, the gas generator having improved reliability at the time of actuation.

As described hereinabove, a hybrid type gas generator using a cylindrical housing includes a combustion chamber accommodating a gas generating agent on the side of a first end portion and a pressurized gas chamber filled with a gas on the side of a second end portion, and the two chambers are separated from each other by a partition wall.

Where the partition wall is welded and fixed to the cylindrical housing, the partition wall does not move at the time of actuation.

However, since it is difficult to weld the partition wall after filling the cylindrical housing with the gas generating agent from the viewpoint of work safety, welding needs to be performed before filling the gas generating agent, which restricts the assembling procedure. Furthermore, when a filling amount of the gas generating agent is different, it is difficult to position the partition wall, and when the partition wall is at an intermediate position in a longitudinal direction of the cylindrical housing, welding accuracy is difficult to ensure. For these reasons, it is difficult to fix the partition wall to the cylindrical housing by welding. Accordingly, a method of press-fitting the partition wall into the cylindrical housing is employed.

When the partition wall which separates the combustion chamber from the pressurized gas chamber is thus press-fitted, it is conceivable that the partition wall moves in the axial direction at the time of actuation and collides with the welded portion between the cylindrical housing and the diffuser portion.

When the partition wall collides with the diffuser portion and damage such as cracking occurs in the welded portion due to the impact, the gas generator may not be able to operate normally to the end.

In the gas generator of the present invention, a stopper means formed on an inner wall surface of the cylindrical housing is made to contact with the partition wall moving in the axial direction, and thereby, movement of the partition wall is stopped, or movement speed of the partition wall is reduced before the partition wall collides with the diffuser portion.

Where the partition wall stops before colliding with the diffuser portion, the welded portion is not damaged. Also, even when the partition wall collides with the diffuser portion, where the impact at the time of the collision is alleviated by reducing the movement speed of the partition wall, the welded portion is likewise not damaged.

Any stopper means may be used as long as it can stop the partition wall moving in the axial direction or reduce the movement speed thereof by coming into contact therewith.

The partition wall is simply in a circular plate shape which matches an internal shape of the cylindrical housing. However, from the viewpoint of facilitating assembling of the gas generator, preferably, the partition wall has a circular plate portion and an annular wall portion extending in one direction from the outer periphery of the circular plate portion, and also has a plurality of through holes in the circular plate portion.

Before actuation, such a partition wall having the circular plate portion and the annular wall portion is disposed such that an outer circumferential surface of the annular wall portion abuts against the inner wall surface of the cylindrical housing. At the time of actuation, the outer circumferential surface of the annular wall portion slides against the inner wall surface of the cylindrical housing. Before actuation, the partition wall is fixed only to serve to retain the gas generating agent against external vibrations or the like.

In the gas generator of the present invention, it is preferable that the stopper means is a reduced diameter portion in which an inner diameter of the cylindrical housing is reduced.

The reduced diameter portion is a portion where the inner diameter (or the inner diameter and an outer diameter) of the cylindrical housing facing the pressurized gas chamber is reduced.

For example, before actuation, a space from the partition wall to the diffuser portion (the rupturable plate) is the pressurized gas chamber, and where L is a length of the pressurized gas chamber, an inner diameter is reduced at an area between the diffuser portion and a position at 1/2L length rather than an area between the partition wall and the position at 1/2L length, so that the portion at 1/2L length becomes the reduced diameter portion.

An annular stepped surface is formed in the reduced diameter portion due to the difference of the inner diameters.

The annular stepped surface may be an annular surface perpendicular to the axial direction of the cylindrical housing or an annular surface inclined with respect to the axial direction of the cylindrical housing.

At the time of actuation, the partition wall moving in the direction of the diffuser portion collides with the reduced diameter portion (the annular stepped surface) and thereby stops moving before colliding with the diffuser portion.

In the gas generator of the present invention, it is preferable that the stopper means is a protruding portion protruding from the inner wall surface of the cylindrical housing.

As the protruding portion, for example, a plurality of independent protruding portions formed at equal intervals in the circumferential direction or an annular protruding portion continuous in the circumferential direction can be used.

At the time of actuation, the partition wall moving in the direction of the diffuser portion collides with the protruding portion and thereby stops moving before colliding with the diffuser portion.

In the gas generator of the present invention, it is preferable that the stopper means is an annular member disposed on the inner wall surface of the cylindrical housing.

The annular member is preferably made of a metal which is the same material as the cylindrical housing.

The annular member may be an annular plate, but from the viewpoint of ease of handling, the annular member preferably has an annular main body portion and an annular wall portion extending in one direction from the outer periphery of the annular main body portion.

Preferably, the annular member is welded and fixed at a position close to the second end of the cylindrical housing, but not in contact with the the diffuser portion.

With such a welding position, the welding operation and the welding spot are easy to confirm from an opening on the side of the diffuser portion, and even when welding is performed after the gas generating agent is filled, the gas generating agent is not adversely affected.

At the time of actuation, the partition wall moving in the direction of the diffuser portion collides with the annular member and thereby stops moving before colliding with the diffuser portion.

In the gas generator of the present invention, it is preferable that the stopper means includes a combination of a protruding portion protruding from the inner wall surface of the cylindrical housing and an annular member press-fitted to the inner wall surface of the cylindrical housing, and the annular member abuts against the protruding portion and is disposed on the side of the combustion chamber with respect to the protruding portion.

As the protruding portion, for example, a plurality of independent protruding portions formed at equal intervals in the circumferential direction or an annular protruding portion continuous in the circumferential direction can be used.

The annular member may be an annular flat plate, but from the viewpoint of ease of handling, the annular member preferably has an annular main body portion and an annular wall portion extending in one direction from the outer periphery of the annular main body portion.

The annular member can be press-fitted and disposed on the side of the combustion chamber with respect to the protruding portion. Therefore, a position of the annular member can be selected within a range between the partition wall and the diffuser portion.

At the time of actuation, the partition wall moving in the direction of the diffuser portion collides with the annular member and then stops moving before colliding with the diffuser portion.

In the gas generator of the present invention, it is preferable that the stopper means is a rough surface section formed on the inner wall surface of the cylindrical housing.

The rough surface section is a section in which the inner wall surface of the cylindrical housing facing the pressurized gas chamber is roughened.

The rough surface is a surface in which fine irregularities are formed on the inner wall surface of the cylindrical housing, for example, a surface that feels rough when touched with a finger, and exhibits a large frictional force when in contact with the partition wall. When a rough surface section is formed on the inner circumferential surface of the housing, a known method such as etching the surface with an acid, sand blasting or the like can be used.

At the time of actuation, the partition wall moving in the direction of the diffuser portion passes through the rough surface section, thereby reduces its movement speed and stops moving before colliding with the diffuser portion, or even when the partition wall collides with the diffuser portion, the impact at the time of a collision is alleviated, so that the welded portion is not damaged.

In the gas generator of the present invention, it is preferable that the stopper means is a cylindrical buffer member disposed in the cylindrical housing.

As the cylindrical buffer member, it is possible to use an elastic body which absorbs an impact by shrinking, such as a cylindrical rubber, a body which absorbs an impact by crushing, such as a cylindrical net, and the like.

At the time of actuation, the partition wall moving in the direction of the diffuser portion collides with the buffer member and thereby stops moving before colliding with the diffuser portion.

With the gas generator of the present invention, when the partition wall disposed between the combustion chamber and the pressurized gas chamber moves in the axial direction at the time of actuation, the partition wall is prevented from colliding with the diffuser portion, or even when the partition wall collides with the diffuser portion, the impact is alleviated.

Therefore, the welded portion between the cylindrical housing and the diffuser portion is not damaged at the time of actuation, and the operational reliability is further enhanced.

The gas generator of the present invention is usable as a gas generator of an airbag apparatus to be installed on a vehicle.

### Embodiments of Invention

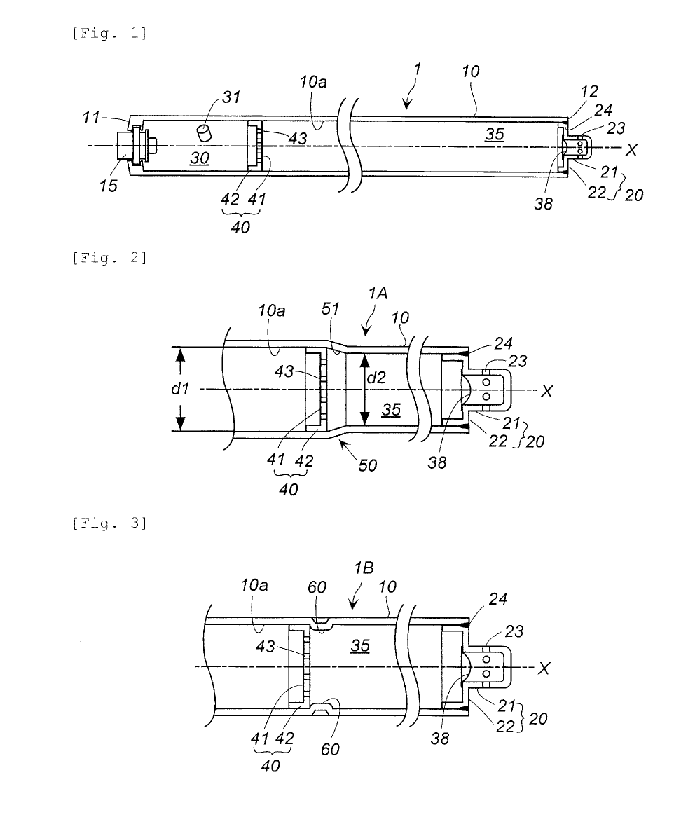

(1) Gas generator depicted in FIGS. 1 and 2

A gas generator 1 depicted in FIG. 1 is in a state before a stopper means (a reduced diameter portion) depicted in FIG. 2 is formed, and a gas generator 1A of the present invention corresponds to the gas generator depicted in FIG. 1 formed with the stopper means depicted in FIG. 2.

An igniter 15 is fixed as an ignition device at a first end portion 11 of a cylindrical housing 10.

The cylindrical housing 10 is made of stainless steel, iron, or the like.

In FIG. 1, only the igniter 15 is used as the ignition device, but a combination of the igniter 15 and a known transfer charge such as boron nitrate can be used as the ignition device.

A diffuser portion 20 is attached at a second end portion 12 opposite to the first end portion 11 of the cylindrical housing 10 in the axis X direction.

The diffuser portion 20 is made of stainless steel, iron, or the like.

The diffuser portion 20 includes a cup portion 21 and a flange portion 22, and is provided with a plurality of gas discharge ports 23 on a circumferential surface of the cup portion 21.

In FIG. 1, the flange portion 22 has an annular portion extending in the axis X direction and is welded and fixed at a contact portion 24 between the annular portion of the flange portion and the second end portion 12 of the cylindrical housing 10 (a welded portion 24).

On the side of the first end portion 11 of the cylindrical housing 10, arranged is a combustion chamber 30 in which a prescribed amount of a gas generating agent 31 is accommodated. The gas generating agent 31 is a known gas generating agent.

In the cylindrical housing 10, a pressurized gas chamber 35 filled with a gas is arranged on the side of the second end portion 12.

The pressurized gas chamber 35 is filled with argon, helium, nitrogen gas or the like under high pressure.

The combustion chamber 30 is separated from the pressurized gas chamber 35 by a partition wall 40.

The partition wall 40 has a circular plate portion 41 and an annular wall portion 42 extending in one direction from the outer periphery of the circular plate portion 41.

The circular plate portion 41 has a plurality of through holes 43 piercing in a thickness direction. Since the gas in the pressurized gas chamber 35 also enters the combustion chamber 30 through the through holes 43, the inside of the combustion chamber 30 is also pressurized.

The partition wall 40 is press-fitted in a state in which an outer circumferential surface of the annular wall portion 42 abuts against an inner wall surface 10a of the cylindrical housing 10 with the annular wall portion 42 located on the side of the igniter 15.

A rupturable plate 38 closes between the pressurized gas chamber 35 and the diffuser portion 20.

The rupturable plate 38 is made of stainless steel, iron, or the like, and a peripheral edge portion thereof is welded and fixed to the flange portion 22 of the diffuser portion 20.

The gas generator 1A (FIG. 2) of the present invention corresponds to the gas generator 1 depicted in FIG. 1 provided with the stopper means (the reduced diameter portion) 50 depicted in FIG. 2.

The reduced diameter portion 50 is simply formed in the pressurized gas chamber 35 such as to be spaced apart from the diffuser portion 20 in the axis X direction to the side of the igniter 15.

When the cylindrical housing 10 is filled with a gas, the gas is filled from a gap at a seal pin inserted into the gas filling hole, and after completion of filling, the seal pin is welded and fixed to the cylindrical housing. In the case of a gas generator in which a seal pin is inserted in the filling hole formed on a circumferential wall of the cylindrical housing, a position of the reduced diameter portion 50 is closer to the igniter 15 than a position of the seal pin.

In the case of a gas generator in which the gas filling hole is formed in the diffuser portion, a position of the reduced diameter portion 50 is decided without consideration of the position of the seal pin.

As depicted in FIG. 2, the reduced diameter portion 50 has an annular inclined surface 51 on the inner side, which is obtained by reducing, toward the diffuser portion 20, an inner diameter (d1 in FIG. 2) of the cylindrical housing 10 in a portion facing the pressurized gas chamber 35 before actuation. The cylindrical housing 10 has a constant inner diameter d1 from a portion where the partition wall 40 is located before actuation to the annular inclined surface 51.

An inner diameter d2 of the cylindrical housing 10 from the annular inclined surface 51 to the diffuser portion 20 is a uniform diameter and satisfies the relationship d1>d2.

A degree of inclination of the annular inclined surface 51 is adjusted by a difference between d1 and d2 and a length of the inclined surface.

Next, an operation of the gas generator 1A, corresponding to the gas generator 1 in FIG. 1 installed with the stopper means (the reduced diameter portion) 50 in FIG. 2, will be described.

When the igniter 15 is actuated, the gas generating agent 31 in the combustion chamber 30 is ignited and burned, and a combustion gas is generated.

When a pressure in the combustion chamber 30 rises due to the generation of the combustion gas, the combustion gas flows into the pressurized gas chamber 35 from the through holes 43 of the partition wall 40.

The partition wall 40 is press-fitted into the cylindrical housing 10 and moves in the axis X direction (toward the diffuser portion 20) under an effect of an impact at the time of combustion and an initial pressure of the combustion gas, while the outer circumferential surface of the annular wall portion 42 slides on the inner wall surface 10a of the cylindrical housing 10.

In the gas generator 1 depicted in FIG. 1, the partition wall 40 stops by colliding with the flange portion 22 of the diffuser portion 20. However, in the gas generator 1A depicted in FIG. 2, the partition wall 40 stops by colliding with the reduced diameter portion 50, which is the stopper means, so that the partition wall 40 does not collide with the diffuser portion 20.

When the pressure in the pressurized gas chamber 35 rises due to the inflow of the combustion gas, the rupturable plate 38 is ruptured and opened. As a result, both the combustion gas and the pressurized gas flow into the diffuser portion 20 and are then discharged from the gas discharge ports 23.

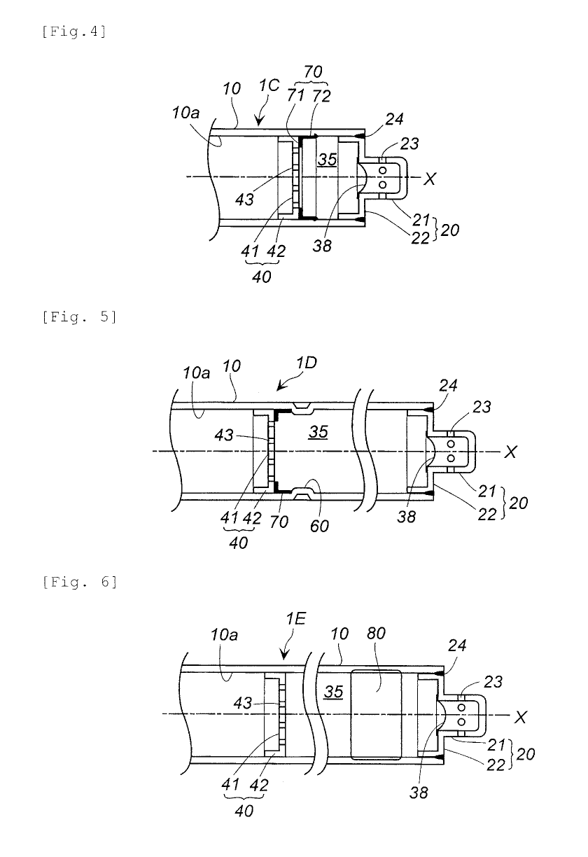

### (2) Gas Generator Depicted in FIGS. 1 and 3

The gas generator 1 depicted in FIG. 1 is in a state before a stopper means (a protruding portion) depicted in FIG. 3 is formed, and a gas generator 1B of the present invention corresponds to the gas generator depicted in FIG. 1 formed with the stopper means depicted in FIG. 3.

The gas generator 1B depicted in FIG. 3 differs from the gas generator 1A depicted in FIG. 2 only by the stopper means. Therefore, only parts different from those in FIG. 2 will be explained hereinbelow.

The gas generator 1B depicted in FIG. 3 has a protruding portion 60 as the stopper means which protrudes from the inner wall surface 10a of the cylindrical housing 10.

The protruding portion 60 is a plurality of independent protruding portions.

In FIG. 3, two protruding portions 60 are shown, but in order to obtain a stopper effect, about 2 to 6 protruding portions 60 may be formed at equal intervals in the circumferential direction.

In the gas generator 1 depicted in FIG. 1, the partition wall 40 stops by colliding with the flange portion 22 of the diffuser portion 20. However, in the gas generator 1B depicted in FIG. 3, the partition wall 40 stops by colliding with the protruding portions 60, which is the stopper means, so that the partition wall 40 does not collide with the diffuser portion 20.

### (3) Gas Generator Depicted in FIGS. 1 and 4

The gas generator 1 depicted in FIG. 1 is in a state before a stopper means (an annular member) depicted in FIG. 4 is formed, and a gas generator 1C of the present invention corresponds to the gas generator depicted in FIG. 1 formed with the stopper means depicted in FIG. 4.

The gas generator 1C depicted in FIG. 4 differs from the gas generator 1A depicted in FIG. 2 only by the stopper means. Therefore, only parts different from those in FIG. 2 will be explained hereinbelow.

The gas generator 1C depicted in FIG. 4 has an annular member 70 as a stopper means fixed to the inner wall surface 10a of the cylindrical housing 10.

The annular member 70 is made of stainless steel, iron, or the like.

The annular member 70 has an annular main body portion 71 and an annular wall portion 72 extending in one direction from the outer periphery of the annular main body portion 71, and is disposed such that the annular wall portion 72 is on the side of the diffuser portion 20.

In the annular member 70, the annular wall portion 72 is welded and fixed to the cylindrical housing 10 at a position close to the diffuser portion 20, but not in contact with the the diffuser portion 20.

In the gas generator 1 depicted in FIG. 1, the partition wall 40 stops by colliding with the flange portion 22 of the diffuser portion 20. However, in the gas generator 1C depicted in FIG. 4, the partition wall 40 stops by colliding with the annular member 70, which is the stopper means, so that the partition wall does not collide with the diffuser portion 20.

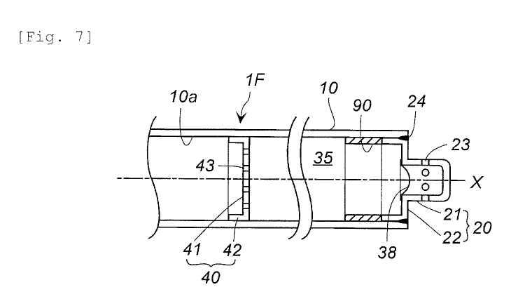

### (4) Gas Generator Depicted in FIGS. 1 and 5

The gas generator 1 depicted in FIG. 1 is in a state before a stopper means (a combination of a protruding portion and an annular member) depicted in FIG. 5 is formed, and a gas generator 1D of the present invention corresponds to the gas generator depicted in FIG. 1 formed with the stopper means depicted in FIG. 5.

The gas generator 1D depicted in FIG. 5 differs from the gas generator 1A depicted in FIG. 2 only by the stopper means. Therefore, only parts different from those in FIG. 2 will be explained hereinbelow.

The gas generator 1D depicted in FIG. 5 has a combination of the protruding portion 60, which protrudes from the inner wall surface 10a of the cylindrical housing 10, and the annular member 70 as a stopper means.

The protruding portion 60 can be the same as the protruding portion 60 depicted in FIG. 3.

The annular member 70 can be the same as the annular member 70 depicted in FIG. 4.

The annular member 70 is press-fitted such that the annular wall portion 72 abuts against the protruding portion 60, and is located on the side of the combustion chamber 30 (on the side of the igniter 15) with respect to the protruding portion 60.

In the gas generator 1 depicted in FIG. 1, the partition wall 40 stops by colliding with the flange portion 22 of the diffuser portion 20. However, in the gas generator 1D depicted in FIG. 5, the partition wall 40 stops by colliding with the annular wall portion 70 supported by the protruding portion 60, which serves as the stopper means, so that the partition wall does not collide with the diffuser portion 20.

### (5) Gas Generator Depicted in FIGS. 1 and 6

The gas generator 1 depicted in FIG. 1 is in a state before a stopper means (a rough surface section) depicted in FIG. 6 is formed, and a gas generator 1E of the present invention corresponds to the gas generator depicted in FIG. 1 formed with the stopper means depicted in FIG. 6.

The gas generator 1E depicted in FIG. 6 differs from the gas generator 1A depicted in FIG. 2 only by the stopper means. Therefore, only parts different from those in FIG. 2 will be explained hereinbelow.

The gas generator 1E depicted in FIG. 6 has a rough surface section 80 as a stopper means formed on the inner wall surface 10a of the cylindrical housing 10.

The rough surface section 80 is a range in which the inner wall surface 10a of the cylindrical housing 10 is made rough and, for example, a surface that feels rough when touched with a finger.

As a method for roughening the inner wall surface 10a, a sandblasting method and also a method of scrubbing with a file, a method of irradiating with a laser, or the like can be used.

A range of the rough surface section 80 is not particularly limited, and the rough surface section can be formed on the entire inner wall surface 10a in the length range between the partition wall 40 to the diffuser portion 20 before actuation, but the range may be about 25% to 50% of this length range.

Further, in order to facilitate the roughening operation, the rough surface section 80 is preferably formed in a range close to the second end portion 12 of the cylindrical housing 10.

Further, in the present embodiment, an outer surface of the annular wall portion 42 of the partition wall 40 can also be a rough surface. By roughening the outer surface of the annular wall portion 42, it is possible to increase further the frictional force generated when the partition wall moves against the rough surface section 80.

In the gas generator 1 depicted in FIG. 1, the partition wall 40 stops by colliding with the flange portion 22 of the diffuser portion 20. However, in the gas generator 1E depicted in FIG. 6, the partition wall 40 moves while sliding on the rough surface section 80, which is the stopper means. Therefore, movement speed of the partition wall is greatly reduced in the course of passing through the rough surface section 80, and the partition wall stops before colliding with the diffuser portion 20, or even when the partition wall collides with the diffuser portion 20, the impact is alleviated, so that the welded portion is not damaged.

### (6) Gas Generator Depicted in FIGS. 1 and 7

The gas generator 1 depicted in FIG. 1 is in a state before a stopper means (a cylindrical buffer member) depicted in FIG. 7 is formed, and a gas generator 1F of the present invention corresponds to the gas generator depicted in FIG. 1 formed with the stopper means depicted in FIG. 7.

The gas generator 1F depicted in FIG. 7 differs from the gas generator 1A depicted in FIG. 2 only by the stopper means. Therefore, only parts different from those in FIG. 2 will be explained hereinbelow.

The gas generator 1F depicted in FIG. 7 has a cylindrical buffer member 90 as a stopper means disposed inside the cylindrical housing 10.

The cylindrical buffer member 90 is disposed such that an outer circumferential surface thereof abuts against the inner wall surface 10a of the cylindrical housing 10 and one end surface thereof abuts against the diffuser portion 20.

As the cylindrical buffer member 90, it is possible to use an elastic body which absorbs an impact by shrinking, such as a cylindrical rubber, a body which absorbs an impact (deforms plastically) by crushing, such as a cylindrical net (a metal or synthetic resin net), and the like.

In the gas generator 1 depicted in FIG. 1, the partition wall 40 stops by colliding with the flange portion 22 of the diffuser portion 20. However, in the gas generator 1F depicted in FIG. 7, the partition wall 40 stops by colliding with the cylindrical buffer member 90, which is the stopper means, so that the partition wall does not collide with the diffuser portion 20.

The invention thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A gas generator, comprising:
an ignition device disposed on the side of a first end portion of a cylindrical housing;
a diffuser portion provided with a gas discharge port, welded and fixed to the cylindrical housing on the side of a second end portion axially opposite to the first end portion;
a combustion chamber accommodating a gas generating agent and being arranged on the side of the first end portion;
a pressurized gas chamber being filled with a gas and arranged on the side of the second end portion;
a partition wall provided with a through hole in a thickness direction thereof and separating the combustion chamber from the pressurized gas chamber;
a rupturable plate closing between the pressurized gas chamber and the diffuser portion; and
a stopper means formed on an inner wall surface of the cylindrical housing, the stopper means stopping movement of the partition wall or reducing movement speed of the partition wall, before the partition wall collides with the diffuser portion, by coming into contact with the partition wall which moves in an axial direction upon receipt of a pressure of a combustion gas generated by combustion of the gas generating agent in the combustion chamber at the time of actuation.

2. The gas generator according to claim 1, wherein the stopper means is a reduced diameter portion in which an inner diameter of the cylindrical housing is reduced.

3. The gas generator according to claim 1, wherein the stopper means is a protruding portion protruding from the inner wall surface of the cylindrical housing.

4. The gas generator according to claim 1, wherein the stopper means is an annular member disposed on the inner wall surface of the cylindrical housing.

5. The gas generator according to claim 1, wherein the stopper means includes a combination of a protruding portion protruding from the inner wall surface of the cylindrical housing and an annular member press-fitted to the inner wall surface of the cylindrical housing, and
the annular member abuts against the protruding portion and is disposed on the side of the combustion chamber with respect to the protruding portion.

6. The gas generator according to claim 1, wherein the stopper means is a rough surface section formed on the inner wall surface of the cylindrical housing.

7. The gas generator according to claim 1, wherein the stopper means is a cylindrical buffer member disposed in the cylindrical housing.
